(19) United States
(12) Patent Application Publication
(10) Pub. No.: US 2009/0148377 A1
(43) Pub. Date: Jun. 11, 2009

(54) Process For Producing Electrode Active Material For Lithium Ion Cell

(76) Inventors: Ralph E. Moshage, Utica, IL (US); Eric Meyer, Toluca, IL (US); Qiuhua Zhang, Peru, IL (US); Scott L. Hoge, Tonica, IL (US); Dan Hartsough, Princeton, IL (US); M. Yazid Saidi, Henderson, NV (US)

Correspondence Address: VALENCE TECHNOLOGY, INC., 1889 E. MAULE AVENUE, SUITE A, LAS VEGAS, NV, 89119, US

(21) Appl. No.: 11/953,953

(22) Filed: Dec. 11, 2007

(51) Int. Cl. C01B 25/30

(52) U.S. Cl. 423/306

(57) ABSTRACT

The present invention relates to a method for preparing a lithium vanadium phosphate material comprising mixing water, lithium dihydrogen phosphate, V₂O₃ and a source of carbon to produce a first slurry; wet blending the first slurry; spray drying the wet blended slurry to form a precursor composition; milling the precursor composition to obtain a milled precursor composition; compacting the milled precursor to obtain a compacted precursor; pre-baking the compacted precursor composition to obtain a precursor composition with low moisture content; and calcining the precursor composition with low moisture content at a time and temperature sufficient to produce a lithium vanadium phosphate. The lithium vanadium phosphate so produced can optionally be further milled to obtain the desired particle size. The electrochemically active lithium vanadium phosphate so produced is useful in making electrodes and batteries and more specifically is useful in producing cathode materials for electrochemical cells.

### FIELD OF THE INVENTION

The present invention relates to the synthesis of electroactive lithium vanadium phosphate materials for use in electrodes, more specifically to cathode active materials for use in lithium ion batteries.

### BACKGROUND OF THE INVENTION

The proliferation of portable electronic devices such as cell phones and laptop computers has lead to an increased demand for high capacity, long endurance light weight batteries. Because of this, alkali metal batteries, especially lithium ion batteries, have become a useful and desirable energy source. Lithium metal, sodium metal, and magnesium metal batteries are well known and desirable energy sources.

By way of example and generally speaking, lithium batteries are prepared from one or more lithium electrochemical cells containing electrochemically active (electroactive) materials. Such cells typically include, at least, a negative electrode, a positive electrode, and an electrolyte for facilitating movement of ionic charge carriers between the negative and positive electrode. As the cell is charged, lithium ions are transferred from the positive electrode to the electrolyte and, concurrently from the electrolyte to the negative electrode. During discharge, the lithium ions are transferred from the negative electrode to the electrolyte and, concurrently from the electrolyte back to the positive electrode. Thus, with each charge/discharge cycle the lithium ions are transported between the electrodes. Such rechargeable batteries are called rechargeable lithium ion batteries or rocking chair batteries.

The electrodes of such batteries generally include an electrochemically active material having a crystal lattice structure or framework from which ions, such as lithium ions, can be extracted and subsequently reinserted and/or permit ions such as lithium ions to be inserted or intercalated and subsequently extracted. Recently, a class of transition metal phosphates and mixed metal phosphates have been developed, which have such a crystal lattice structure. These transition metal phosphates are insertion based compounds like their oxide based counterparts. The transition metal phosphates and mixed metal phosphates allow great flexibility in the design of lithium ion batteries.

Recently, three-dimensional structured compounds comprising polyanions such as (SO₄)ⁿ⁻, (PO₄)ⁿ⁻, (AsO₄)ⁿ⁻, and the like, have been proposed as viable alternatives to oxide based electrode materials such as LiMₓO_{y}. A class of such materials is disclosed in U.S. Pat. No. 6,528,033 B1 (Barker et al.) The compounds therein are of the general formula LiₐMI_{b}MII_{c}(PO₄)_{d} wherein MI and MII are the same or different. MI is a metal selected from the group consisting of Fe, Co, Ni, Mn, Cu, V, Sn, Ti, Cr and mixtures thereof. MII is optionally present, but when present is selected from the group consisting of Mg, Ca, Zn, Sr, Pb, Cd, Sn, Ba, Be, and mixtures thereof. An example of such polyanion based material includes the NASICON compound of the nominal general formula Li₃V₂(PO₄)₃, and the like.

In general, when such materials are used as cathode materials, they must exhibit a high free energy of reaction with lithium, be able to intercalate a large quantity of lithium, maintain its lattice structure upon insertion and extraction of Ithium, allow rapid diffusion of lithium, afford good electrical conductivity, not be significantly soluble in the electrolyte system of the battery, and be readily and economically produced. However, many of the cathode materials known in the art lack one or more of these characteristics.

Although these compounds find use as electrochemically active materials useful for producing electrodes these materials are not always economical to produce and due to the chemical characteristics of the starting materials sometimes involve extensive processing to produce such compounds. Methods for preparing such compounds on a laboratory scale do not always lend themselves to efficient and reproducible processes on a manufacturing level. The present invention provides an economical, reproducible and efficient process for producing, on a manufacturing scale, lithium vanadium phosphate with good electrochemical properties.

### SUMMARY OF THE INVENTION

The present invention relates to a method for preparing a lithium vanadium phosphate material comprising mixing water, lithium dihydrogen phosphate, V₂O₃ and a source of carbon to produce a first slurry; wet blending the first slurry; spray drying the wet blended slurry to form a precursor composition; milling the precursor composition to obtain a milled precursor composition; compacting the milled precursor to obtain a compacted precursor; pre-baking the compacted precursor composition to obtain a precursor composition with low moisture content; and calcining the precursor composition with low moisture content at a time and temperature sufficient to produce a lithium vanadium phosphate. The lithium vanadium phosphate so produced can optionally be further milled to obtain the desired particle size. The electrochemically active lithium vanadium phosphate so produced is useful in making electrodes and batteries and more specifically is useful in producing cathode materials for electrochemical cells.

### BRIEF DESCRIPTION OF THE DRAWINGS

FIG. 1 shows the XRD pattern for lithium vanadium phosphate made by the process of the present invention.

FIG. 2 shows the cycling data at 4.6V using the lithium vanadium phosphate made by the process of the present invention.

### DETAILED DESCRIPTION

The present invention relates to a manufacturing method for preparing an electroactive lithium vanadium phosphate of the nominal general formula Li₃V₂(PO₄)₃. Such method produces quality and consistent batches of lithium vanadium phosphate.

Metal phosphates, and mixed metal phosphates and in particular lithiated metal and mixed metal phosphates have recently been introduced as electrode active materials for ion batteries and in particular lithium ion batteries. These metal phosphates and mixed metal phosphates are insertion based compounds. What is meant by insertion is that such materials have a crystal lattice structure or framework from which ions, and in particular lithium ions, can be extracted and subsequently reinserted and/or permit ions to be inserted and subsequently extracted.

The transition metal phosphates allow for great flexibility in the design of batteries, especially lithium ion batteries. Simply by changing the identity of the transition metal allows for regulation of voltage and specific capacity of the active materials. Examples of such transition metal phosphate cathode materials include such compounds of the nominal general formulae LiFePO₄, Li₃V₂(PO₄)₃ and LiFe₁₋ₓMgₓPO₄ as disclosed in U.S. Pat. No. 6,528,033 B1 (Barker et al, hereinafter referred to as the '033 patent) issued Mar. 4, 2003.

A class of compounds having the nominal general formula Li₃V₂(PO₄)₃ (lithium vanadium phosphate or LVP) are disclosed in U.S. Pat. No. 6,528,033 B1. It is disclosed therein that LVP can be prepared by ball milling V₂O₅, Li₂CO₃, (NH₄)₂HPO₄ and carbon, and then pelletizing the resulting powder. The pellet is then heated to 300° C. to remove CO₂ from the LiCO₃ and to remove the NH₂. The pellet is then powderized and repelletized. The new pellet is then heated at 850° C. for 8 hours to produce the desired electrochemically active product.

It has been found that when making lithium vanadium phosphate by the method of the '033 patent that problems result from the dry ball mixing method. The dry ball-mill mixing method on a larger production scale sometimes results in an incomplete reaction of the starting materials. When the incomplete reaction occurs and the product so produced is used in a cell it produces a cell with poor cycle performance. The method on a large scale also resulted in poor reproducibility of the product formed.

Additionally, it has been found that when lithium vanadium phosphate (prepared using the methods of the '033 patent on a larger scale) is used in the preparation of phosphate cathodes it results in phosphate cathodes with high resistivity. The lithium vanadium phosphate powders produced by the method of the '033 patent on a large scale also exhibit a low tap density.

Previous methods for producing lithium vanadium phosphate utilized insoluble vanadium compounds either mixed in the dry state or mixed in aqueous solution with other precursors that may or may not have been soluble. Unless the dry mixing method was done with very high shear for a long period of time, it tended to leave traces of precursor in the final product. Both of these mixing methods required that the insoluble vanadium precursor be milled to a small particle size in order to overcome diffusion limitations during synthesis. Calcination of the precursor mix using insoluble vanadium tended to require at least 8 hours at 900° C. to get complete conversion.

It has now surprisingly been found that lithium vanadium phosphate can be prepared in a beneficial manner to produce materials with high electronic conductivity and an excellent cycle life with superior reversible capacity. The present invention is beneficial over previously disclosed processes in that it reduces mixing time, improves homogeneity of the precursor mixture, reduces calcination time and results in improved performance of the lithium vanadium phosphate as a lithium-ion cathode material.

In one embodiment of the invention the lithium vanadium phosphate is produced by a wet blend method. The process comprises forming an aqueous mixture comprising H₂O, lithium hydrogen diphosphate (LHP), V₂O₃ and a source of carbon. The aqueous slurry is then subjected to high shear mixing (wet belending). The mixture is then spray dried (to remove the water) to form a precursor composition. The precursor composition is then milled and granulated to obtain a granulated milled precursor composition. The granulated milled precursor composition is then pre-baked to obtain a precursor composition with low moisture content. The precursor composition with low moisture content is then heated or calcined to produce the lithium vanadium phosphate product. The lithium vanadium phosphate so produced is then, optionally, milled in a fluidized jet mill.

Previous methods of making LVP involved ball milling dry starting materials to a homogeneous mixture. To obtain a homogeneous mixture required much time and often during the mixing hard crystals of LHP would form. This further increased the processing time and increased wear and tear on media and processing equipment.

In the present invention, dispersing the soluble LHP in water provides for the dissolution of the LHP which is an improvement over other known processes because it avoids formation of hard crystals of LHP. When the slurry is spray dried to remove the water it produces a precursor material that is homogenous and the crystals formed by spray drying are very small (for example about 40 μm), and easily reduced in size by ball milling. This reduces processing time and also reduces the presence of unwanted impurities in the final lithium vanadium phosphate product. Uniformity of particle size can be obtained by ball milling.

After preparation of the precursor materials and prior to calcinations, previously known processes used pelletization for compaction of the particles. The pelletizing equipment produce a pellet that varies in compaction in that the pellets are harder on the edges and softer in the middle.

In the process of the present invention the compaction of the particles is preferably achieved by granulation. Such compaction or granulation step improves particle to particle contact and improves handling characteristics of the precursor material. The milled powder is compacted into a corrugated sheet between rollers at a pressure of about 2000 psi, and then the sheet is broken into granules approximately 3/16 inch in diameter in a Fitz mill. This process produces evenly compacted granules which give improved conversion to lithium vanadium phosphate, with less impurities in the final product (after the subsequent calcinations step) due to the improved particle to particle contact afforded by the compaction. The granules are also easier to handle than the milled precursor powder in the subsequent process steps.

The granules are then pre-baked at a low temperature for a sufficient amount of time to remove moisture content. The moisture content is preferably less than 1%. The pre-baking occurs at temperatures from about 250° C. to about 400° C., and preferably at about 350° C. The pre-baking takes from about 2 hours to about 8 hours and preferably about 4 hours. Such pre-baking produces a precursor composition with low moisture content. Removal of the moisture prevents H₂ (hydrogen) formation in the subsequent calcinations step. Such hydrogen formation results in a final lithium vanadium phosphate product with undesirable impurities.

The low moisture content precursor composition is then calcined. Previous methods of calcining used retort furnaces which lose efficiency as batch size increases. In such retort furnaces as the depth of the product increases the product is heated unevenly resulting in a non-uniform product. Also in such retort furnaces escape gases containing hydrogen that are formed have to filter through increasing amounts of product before they are removed from the furnace. If excessive exposure of the product to hydrogen occurs during calcination, formation of impurities in the final product is promoted which impairs battery performance if such impurity is present in the cathode material.

The present invention involves calcination in a rotary furnace. A rotary furnace is better suited to continuous, high-rate material processing than in a retort furnace. Furthermore, in a rotary furnace the bed depth of the product remains small and does not vary by batch size. The undesired escape gases have very little material to pass through thus resulting in less impurity in the final product. The calcination step takes place at about 700° C. to about 1050° C. and more preferably at about 900° C. The calcination occurs for about 30 minutes to about four hours and preferably for about one hour to produce a quality lithium vanadium phosphate.

The carbon used can be an elemental carbon, preferably in particulate form such as graphites, amorphous carbon, carbon blacks and the like. The carbon is added in an amount from about 0.1 weight percent to about 30 weight percent, preferably from about 1 weight percent to about 12 weight percent and more preferably from about 4 weight percent to about 12 weight percent. The carbon remaining in the reaction product functions as a conductive constituent in the ultimate electrode or cathode formulation. This is an advantage since such remaining carbon is very intimately mixed with the reaction product material.

The lithium dihydrogen phosphate (LHP) is the phosphate ion source and the lithium ion source for the final product. On the manufacturing scale LHP is added in an amount from about 32.0 kg to about 32.3 kg for a 50 kg precursor batch. LHP is added to account for approximately 2% excess in the precursor formulation. The V₂O₃ is the vanadium ion source for the final product. On a manufacturing scale V₂O₃ is added in an amount from about 15.4 kg to about 15.55 kg for a 50 kg precursor batch. The LHP/V₂O₃/C are added in a ratio of about 3:1:0.25. The amount of water used on a manufacturing scale is typically about 120 kg per 50 kg precursor batch.

The starting materials are mixed to form a slurry. The slurry is mixed in a high shear mixture such as an Attritor mixer, (such as can be purchased from Cowles). The wet blending of the slurry can be completed in about 1 minute to about 10 hours, preferably from about 2 minutes to about 5 hours and more preferably for about 2 hours. One skilled in the art will recognize that stirring times can vary depending on factors such as temperature and size of the reaction vessel and amounts and choice of starting materials. The stirring times can be determined by one skilled in the art based on the guidelines given herein, choice of reaction conditions and the sequence that the starting materials are added to the slurry.

The slurry, containing the water, a source of carbon, the LHP and V₂O₃ is spray dried using conventional spray drying equipment and methods. The slurry is spray dried by atomizing the slurry to form droplets and contacting the droplets with a stream of gas at a temperature sufficient to evaporate at least a major portion of the solvent used in the slurry. In one embodiment air can be used to dry the slurries of the invention. In other embodiments, it may be preferable to use a less oxidizing or an inert gas or a gas mixture. Spray drying produces a powdered, essentially dry precursor composition.

Spray drying is preferably conducted using a variety of methods that cause atomization by forcing the slurry under pressure at a high degree of spin through a small orifice, including rotary atomizers, pressure nozzles, and air (or two-fluid) atomizers. The slurry is thereby dispersed into fine droplets. It is dried by a relatively large volume of hot gases sufficient to evaporate the volatile solvent, thereby providing very fine particles of a powdered precursor composition. The particles contain the precursor starting materials intimately and essentially homogeneously mixed. The spray-dried particles appear to have the same uniform composition regardless of their size. In general, each of the particles contains all of the starting materials in the same proportion. The particle size is less than about 100 μm and preferably less than about 50 μm.

Desirably the volatile constituent in the slurry is water. The spray drying may take place preferably in air or in an inert hot gas stream. A preferred hot drying gas is argon, though other inert gases may be used. The temperature at the gas of the outlet of the dryer is preferably greater than about 90-100° C. The inlet gas stream is at an elevated temperature sufficient to remove a major portion of the water with a reasonable drier volume, for a desired rate of dry powder production and particle size. Air inlet temperature, atomize droplet size, and gas flow are factors which may be varied and affect the particle size of the spray dry product and the degree of drying. There may typically be some water or solvent left in the spray dried material. For example, there may be up to 1-5% by weight water. It is preferred that the spray drying step reduce the moisture content of the material to less than 5% by weight and more preferably 1% or less. The amount of solvent removed depends on the flow rate, residence time of the solvent water particles, and contact with the heated air, and also depends on the temperature of the heated air.

Techniques for spray drying are well known in the art. In a non-limiting example, spray drying is carried out in a commercially available spray dryer such as an APV-lnvensys PSD52 Pilot Spray Dryer. Typical operating conditions are in the following ranges: inlet temperature 250-350° C. (preferably 350° C.); outlet temperature: 100-150° C. (preferably 135° C.); feed rate: 4-8 liters (slurry) per hour and Rotary atomizer set at about 25,000 RPM.

The term milling as used herein often times specifically refers to ball milling. However, it is understood by those skilled in the art, that the term as used herein and in the claims can encompass processes similar to ball milling which would be recognized by those with skill in the art. For instance, the starting materials can be blended together, put in a commercially available muller and then the materials can be mulled. Alternatively, the starting materials can be mixed by high shear and/or using a ball mill to mix the materials. The purpose of the milling step, without being limited hereby, is to provide a more homogeneous mixture of the precursor components and to reduce particle size. As a result, the reaction rate during subsequent calcinations increased and impurities in the final product are decreased.

The precursor composition is then milled, mulled or milled and mulled for about 2 hours to about 24 hours, preferably for about 4 hours when a dry ball mix procedure is used to produce a milled precursor compound. The particle size after this step is preferably about 20 μm. The amount of time required for milling is dependent on the intensity of the milling. For example, in small testing equipment the milling takes a longer period of time then is needed with industrial equipment.

Compaction of the milled precursor composition is desirable to provide more intimate inter-particle contact, resulting in more complete conversion to the final product, reduced impurities in the final product, and improved handling of the precursor during the subsequent pre-bake and calcining steps. Compaction can be achieved by pelletizing the powder, but for uniform compaction and speed of processing granulation is preferred.

The granulated or compacted precursor is then pre-baked in a tray oven with sufficient airflow to carry away water vapor. The pre-baking removes moisture to prevent H₂ contamination during the subsequent calcination step. If water is present during calcination it can be reduced to form hydrogen when the precursor is heated at high temperatures during calcination. If hydrogen is present during calcinations it promotes impurity formation in the final product which then results in reduced battery performance when the final product is employed in the cathode of a battery. The moisture content after pre-baking is preferably less than 1% to produce a precursor composition with low moisture content. Pre-baking occurs at temperatures from about 250° C. to about 400° C. and preferably 350° C. The precursor composition is pre-baked for about 30 minutes to about 8 hours and preferably about 1 to about 4 hours to produce the precursor composition with low moisture content.

In a final step the electroactive lithium vanadium phosphate product is prepared by calcining (heating) the precursor composition with low moisture content for a time and at a temperature sufficient to form a lithium vanadium phosphates reaction product. The precursor composition with low moisture content is heated (calcined) in a rotary kiln, generally at a temperature of about 400° C. to about 1050° C., and preferably at about 900° C. until the lithium vanadium phosphate reaction product forms.

It is preferred to heat the precursor composition at a ramp rate in a range from a fraction of a degree to about 20° C. per minute. The ramp rate is to be chosen according to the capabilities of the equipment on hand and the desired turnaround or cycle time. As a rule, for faster turnaround it is preferred to heat up the sample at a relatively fast rate. High quality materials may be synthesized, for example, using ramp rates of 2° C./min, 4° C./min, 5° C./min and 10° C./min. Once the desired temperature is attained, the reactions are held at the reaction temperature for about 10 minutes to several hours, depending on the reaction temperature chosen. The heating is preferably conducted under an inert atmosphere, such as nitrogen, argon, carbon dioxide, and the like or mixtures thereof. The flow rate of the purge gas is adjusted so as to effectively remove water vapor from the reaction vessel, thereby preventing the undesirable formation of hydrogen.

After reaction, the products are cooled from the elevated temperature to ambient (room) temperature. The rate of cooling is selected depending on, among other factors, the capabilities of the available equipment, the desired turnaround time, and the effect of cooling rate on the quality of the active material. It is believed that most active materials are not adversely affected by a rapid cooling rate. The cooling may desirably occur at a rate of up to 50° C./minute or higher. Such cooling has been found to be adequate to achieve the desired structure of the final product in some cases. It is also possible to quench the products at a cooling rate on the order of about 100° C./minute.

The lithium vanadium phosphate product optionally and preferably undergoes a final size reduction step to produce particle size of less than about 30 μm and preferably less than about 20 μm. Various milling equipment is available for particle size reduction. Fluidized bed jet milling is preferred for speed of processing and for low levels of iron contamination which is common in other mill types due to attrition of metal parts. Fluidized bed jet milling uses air jets in combination with high efficiency centrifugal air classification to provide high probability of particle on particle impact for breakage into fine powders, without contamination.

The lithium vanadium phosphate material produced by the above described method is usable as an electrode active material, for lithium ion (Li⁺) removal and insertion. These electrodes are combined with a suitable counter electrode to form a cell using conventional technology known to those with skill in the art. Upon extraction of the lithium ions from the lithium metal phosphates or lithium mixed metal phosphates, significant capacity is achieved.

The following is a list of some of the definitions of various terms used herein:

As used herein “battery” refers to a device comprising one or more electrochemical cells for the production of electricity. Each electrochemical cell comprises an anode, cathode, and an electrolyte.

As used herein the terms “anode” and “cathode” refer to the electrodes at which oxidation and reduction occur, respectively, during battery discharge. During charging of the battery, the sites of oxidation and reduction are reversed.

As used herein the term “nominal formula” or “nominal general formula” refers to the fact that the relative proportion of atomic species may vary slightly on the order of 2 percent to 5 percent, or more typically, 1 percent to 3 percent.

As used herein the words “preferred” and “preferably” refer to embodiments of the invention that afford certain benefits under certain circumstances. The recitation of one or more preferred embodiments, however, does not imply that other embodiments are not useful and is not intended to exclude other embodiments from the scope of the invention.

The following Examples are intended to be merely illustrative of the present invention, and not limiting thereof in either scope or spirit. Those with skill in the art will readily understand that known variations of the conditions and processes described in the Examples can be used to synthesize the compounds of the present invention.

Unless otherwise indicated all starting materials and equipment employed were commercially available.

### EXAMPLE 1

### Preparation of LVP

Approximately one metric ton of lithium vanadium phosphate was prepared according to the following procedure. Multiple batches of LHP, V₂O₃ and carbon were mixed in water and spray dried. A single batch consisted of LHP (32.29 kg, Suzhou), was dissolved in deionized water (120 kg). V₂O₃ (15.44 kg, Stratcor), and Super P (2.269 kg, Timcal), were added to the LHP solution in an Attritor Mixer to form a slurry. The slurry was spray dried (350° C. in/142° C. out) to form a homogenous precursor composition. The precursor composition was ball-milled for 4 hours to form a milled precursor composition. The resulting milled precursor composition was granulated at 2000 psi roller pressure to form 3/16 inch diameter granules. The granulated precursor was then pre-baked in a tray oven at 260° C. for about 4 hours to form a precursor composition with moisture content of less than 1%. The resulting granulated precursor composition with low moisture content was calcined in a rotary kiln at 900° C. for about one hour to produce lithium vanadium phosphate.

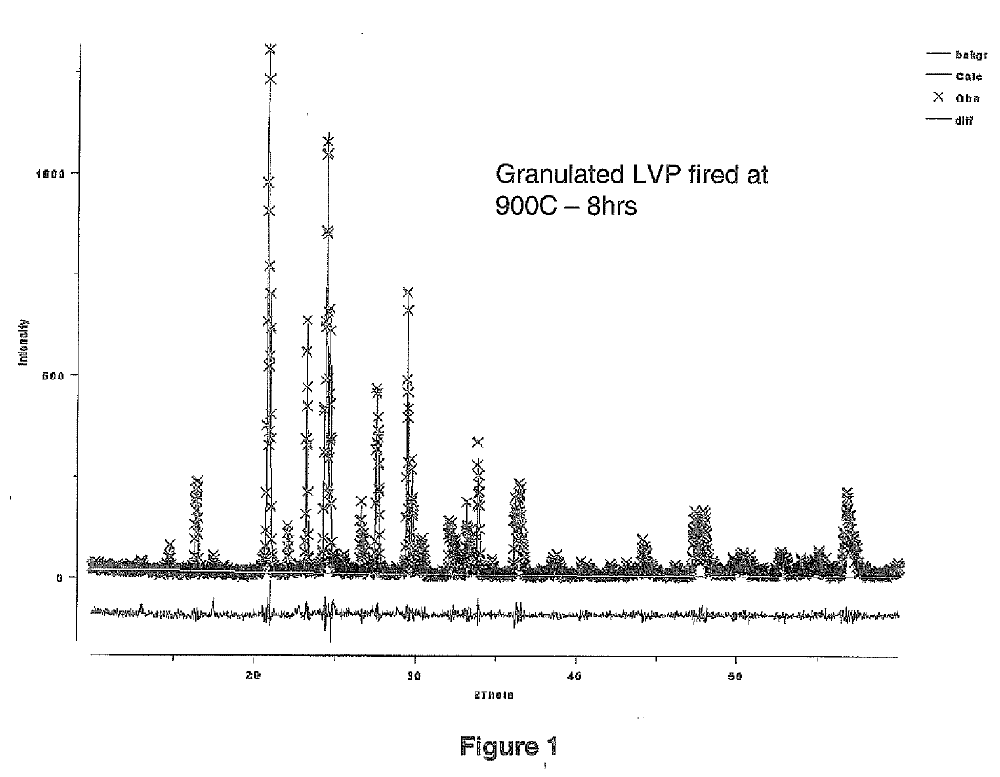

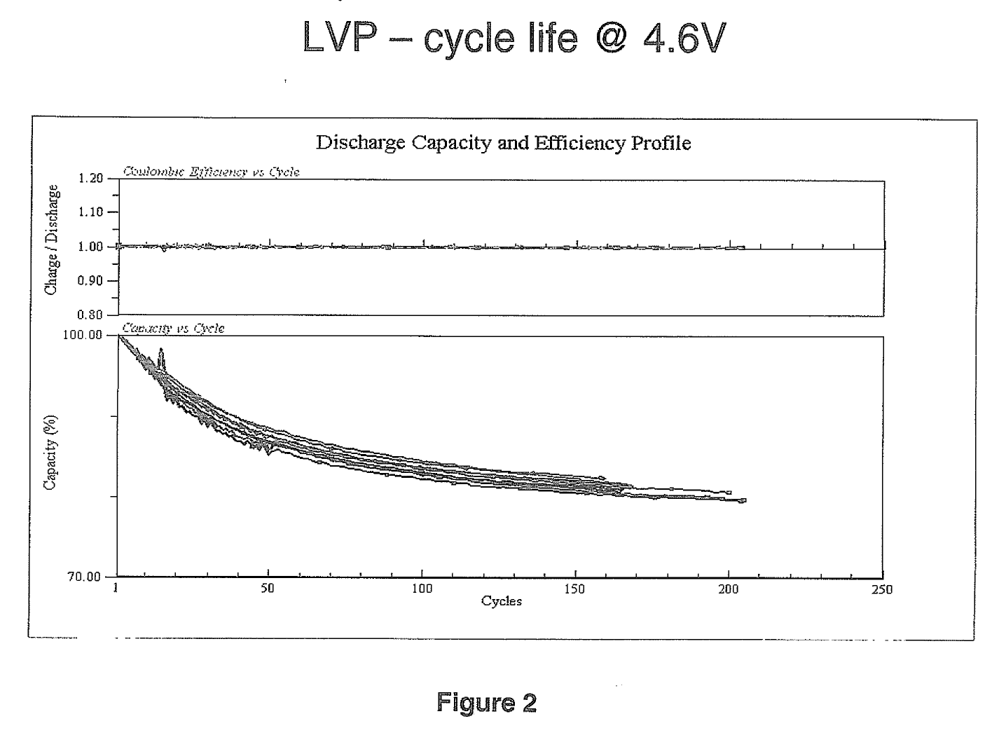

The lithium vanadium phosphate was treated by fluidized jet milling to achieve a final particle size of less than about 10 μm. The XRD pattern for the material so produced is shown in FIG. 1. FIG. 2 shows cycling data of the lithium vanadium phosphate so produced.

The lithium vanadium phosphate produced by the above described methodology finds use as an active material for electrodes in ion batteries and more preferably in lithium ion batteries. The lithium vanadium phosphate produced by the present invention is useful as an active material in electrodes of batteries, and more preferably is useful as an active material in positive electrodes (cathodes). When used in the positive electrodes of lithium ion batteries these active materials reversibly cycle lithium ions with the compatible negative electrode active material.

The active material of the compatible counter electrodes is any material compatible with the lithium vanadium phosphate of the present invention. The negative electrode can be made from conventional anode materials known to those skilled in the art. The negative electrode can be comprised of a metal oxide, particularly a transition metal oxide, metal chalcogenide, carbon, graphite, and mixtures thereof.

A typical laminated battery in which such material can be employed includes, but is not limited to batteries disclosed in the '033 patent For example a typical bi-cell can comprise a negative electrode, a positive electrode and an electrolyte/separator interposed between the counter electrodes. The negative and positive electrodes each include a current collector. The negative electrode comprises an intercalation material such as carbon or graphite or a low voltage lithium insertion compound, dispersed in a polymeric binder matrix, and includes a current collector, preferably a copper collector foil, preferably in the form of an open mesh grid, embedded in one side of the negative electrode. A separator is positioned on the negative electrode on the side opposite of the current collector. A positive electrode comprising a metal phosphate or mixed metal phosphate of the present invention is positioned on the opposite side of the separator from the negative electrode. A current collector, preferably an aluminum foil or grid, is then positioned on the positive electrode opposite the separator. Another separator is positioned on the side opposite the other separator and then another negative electrode is positioned upon that separator. The electrolyte is dispersed into the cell using conventional methods. In an alternative embodiment two positive electrodes can be used in place of the two negative electrodes and then the negative electrode is replaced with a positive electrode. A protective bagging material can optionally cover the cell and prevent infiltration of air and moisture. U.S. Pat. No. 6,528,033 B1, Barker et al. is hereby incorporated by reference.

The electrochemically active compounds of the present invention can also be incorporated into conventional cylindrical electrochemical cells such as described in U.S. Pat. No. 5,616,436, U.S. Pat. No. 5,741,472 and U.S. Pat. No. 5,721,071 to Sonobe et al. Such cylindrical cells consist of a spirally coiled electrode assembly housed in a cylindrical case. The spirally coiled electrode assembly comprises a positive electrode separated by a separator from a negative electrode, wound around a core. The cathode comprises a cathode film laminated on both sides of a thick current collector comprising a foil or wire net of a metal.

An alternative cylindrical cell as described in U.S. Pat. No. 5,882,821 to Miyasaka can also employ the electrochemically active materials produced by the method of the present invention. Miyasaka discloses a conventional cylindrical electrochemical cell consisting of a positive electrode sheet and a negative electrode sheet combined via a separator, wherein the combination is wound together in spiral fashion. The cathode comprises a cathode film laminated on one or both sides of a current collector.

The active materials produced by the method of the present invention can also be used in an electrochemical cell such as described in U.S. Pat. No. 5,670,273 to Velasquez et al. The electrochemical cell described therein consists of a cathode comprising an active material, an intercalation based carbon anode, and an electrolyte there between. The cathode comprises a cathode film laminated on both sides of a current collector.

While this invention has been described in terms of certain embodiments thereof, it is not intended that it be limited to the above description. The description of the invention is merely exemplary in nature and, thus, variations that do not depart from the gist of the invention are intended to be within the scope of the invention Such variations are not to be regarded as a departure from the spirit and scope of the invention.

What is claimed is:

1. A method for making lithium vanadium phosphate comprising:
mixing water, lithium hydrogen phosphate, V₂O₃, and a source of carbon to produce a first slurry,
wet blending the first slurry,
spray drying the wet blended slurry to produce a precursor composition;
milling the precursor composition to obtain a milled precursor composition;
compacting the milled precursor composition to obtain a compacted precursor;
pre-baking the compacted precursor to obtain a precursor composition with low moisture content; and
calcining the precursor composition with low moisture content at a time and temperature sufficient to produce lithium vanadium phosphate.

2. The method according to claim 1 wherein the particle size after spray drying is less than about 100 μm.

3. The method according to claim 2 wherein the particle size is less than about 50 μm.

4. The method according to claim 1 further comprising milling the lithium vanadium phosphate to obtain a particle size of less than about 30 μm.

5. The method according to claim 4 wherein the lithium vanadium phosphate is milled to a final particle size of less than about 20 μm.

6. The method according to claim 4 wherein the milling of the lithium vanadium phosphate is performed in a fluidized bed jet mill.

7. The method according to claim 1 wherein the compacting is performed by pelletization or granulation.

8. The method according to claim 7 wherein the compacting is granulation and is performed at about 2000 psi.

9. The method according to claim 8 wherein the granulation produces granules of about 3/16 inch diameter.

10. The method according to claim 1 wherein the pre-baking is performed at about 250° C. to about 400° C.

11. The method according to claim 10 wherein the pre-baking is performed at about 350° C.

12. The method according to claim 1 wherein the precursor composition with low moisture content has a moisture content of less than about 1%.

13. The method according to claim 1 wherein the calcining step is performed using a rotary furnace.

14. The method according to claim 1 wherein the calcining is performed at a temperature of about 650° C. to about 1050° C.

15. The method according to claim 14 wherein the calcining is performed at 900° C.

16. The method according to claim 14 wherein calcining is performed for about 1 to about 5 hours.

17. The method according to claim 15 wherein the calcining is performed for about 1 hour.

18. The method according to claim 17 wherein the calcining is performed in a rotary furnace.

19. An electrode comprising lithium vanadium phosphate prepared by the method of claim 1.

20. A battery comprising an electrode according to claim 14.
